(19) United States
(12) Patent Application Publication
(10) Pub. No.: US 2016/0299074 A1
(43) Pub. Date: Oct. 13, 2016

(54) METHOD AND DEVICE FOR TESTING THE SURFACE QUALITY OF A COMPONENT IN PARTICULAR OF A CFRP COMPONENT

(71) Applicant: Airbus Defence and Space GmbH, Ottobrunn (DE)

(72) Inventor: Thomas MEER, Egmating (DE)

(21) Appl. No.: 15/097,561

(22) Filed: Apr. 13, 2016

(30) Foreign Application Priority Data
Apr. 13, 2015 (EP) 15001052.8

(51) Int. Cl. G01N 21/64

(52) U.S. Cl. CPC G01N 21/64

(57) ABSTRACT

A method for testing the surface quality of a component, in particular to demonstrate the suitability of the component for coating or bonding. In the method, the surface of the component is wetted with a test liquid, a fluorescent primer is applied as the test liquid and subsequently dried on the surface, and irradiated by means of a light source such that regions lacking surface quality become optically visible on the surface on account of fluorescence.

### CROSS-REFERENCE TO RELATED APPLICATION

This application claims priority to European Patent Application No. 15001052.8, filed Apr. 13, 2015, which is incorporated herein by reference in its entirety.

### TECHNICAL FIELD

The embodiments described herein relate to a method for testing the surface quality of a component, in particular of a CFRP component, to demonstrate the suitability of the component for coating or bonding, in which method the surface of the component is wetted with a test liquid. In addition, the embodiments described herein relate to a device for carrying out the method on a component.

### BACKGROUND

This relates to the production of components to be coated or bonded, in which a minimum surface quality has to be ensured so as to be able to carry out the coating or bonding procedure without errors. For this purpose, the corresponding component surfaces must have sufficient adhesion and wetting properties. The properties of the component surfaces are usually already determined in a preceding shaping process, such as polymer injection moulding, metal die casting or laminating, since during these shaping processes the components are often contaminated by separating agents based on fluorinated hydrocarbons, silicones, oils or waxes. In mechanical processing by means of tensioning manufacturing methods, the component surface may become contaminated by cooling emulsions and cutting oils.

Such component surfaces are therefore sometimes pre-treated prior to further processing by means of an incredibly complex cleaning or activating step.

DE 10 2005 027 106 B3 discloses a generic method for testing the surface quality of a component. A water spray mist is first produced as the test liquid. This mist is brought into contact with the surface of the component to be tested in order to produce droplets of the spray mist on the surface. In a pre-selected region of the surface to be tested, the droplets thus formed are optically detected and defined in terms of the value distribution of a droplet property, for example volumes, visible surfaces, and sizes and/or shape factors. The value distribution determined is then compared with a reference value distribution in order to determine the surface quality of the pre-selected region.

However, this test method may in some cases only work on completely smooth surfaces. Tests have shown that this method does not necessarily allow for small fault points to be sufficiently recognized. Therefore, the method cannot reliably be used on textured surfaces that occur in a large number of CFRP components, for example, due to grinding processes or peel plies to be removed. In addition, when using water as the test liquid, the component has to be completely dried before it can be further processed.

Other methods for testing surfaces may include IR spectroscopy. Such methods may, however, not be sufficiently surface-sensitive, and not all specific contaminants can be detected using the methods. Furthermore, not all generic test methods can be integrated into an automated manufacturing process.

### SUMMARY

One idea is to provide a method and a device for testing the surface quality of a component, in particular of a CFRP component having a textured surface, by means of which the suitability of the component for coating and bonding can be reliably determined in a simple manner.

According to the disclosure, a fluorescent primer is applied to the test surface of the component as the test liquid is subsequently dried on the surface and is then irradiated by means of a light source such that regions lacking surface quality become optically visible on the surface.

The solution according to an embodiment is advantageous in particular in that the fluorescent primer used as the test liquid makes it possible, by means of the fluorescence, to visually discern, in a reliable manner, how the surface is covered with contaminants, for example siloxanes, and the integrated primer property improves the adhesion of a coating or adhesive which leads to an increased resistance of the coating or bond to ageing. The method according to the invention can also be used for textured surfaces and even reliably exposes minor fault points.

The fluorescent primer may be sprayed onto the surface. This allows for this specific test liquid to be applied uniformly over the regions of the surface to be tested. This can be carried out either manually or in an automated manner using a spraying apparatus. In order to show components which are difficult to bond, it is even sufficient to apply the specific test liquid in a partially sprinkled manner.

In order to minimize the testing time, it is proposed to dry the sprayed-on florescent primer using a heat source pointing towards the surface. In this case, a radiant heat source should preferably be used so as not to impair the distribution of the test liquid on the surface.

According to some embodiments, the dried fluorescent primer may be irradiated by means of a light source which emits ultraviolet light, known as black light. Ultraviolet light makes it easier to identify the regions lacking surface quality, contaminants being shown by regions which fluoresce to varying degrees. This means that regions having different amounts of contaminants fluoresce to varying degrees. These regions lacking suitability for coating and bonding are converted, at least in part, into regions having sufficient coating or bonding suitability by means of the integrated primer property of the test liquid. Only if the surface were very contaminated would additional treatment thereof be necessary in order to obtain coating or bonding suitability. Therefore, the method according to the embodiment also saves on possible intermediate method steps.

The method according to an embodiment may be carried out using a device that comprises a spraying unit for wetting the surface of the component with the specific test liquid and an additional light source for illuminating the treated surface with ultraviolet light. Within the context of additional automation, a heat source for drying the treated surface more quickly can be added to the device. Furthermore, it is possible to equip the device with an optical camera unit and a downstream evaluation unit in order to automatically test the surface quality of the component by comparing patterns.

### BRIEF DESCRIPTION OF THE DRAWINGS

The various embodiments will hereinafter be described in conjunction with the following drawing figures, wherein like numerals denote like elements, and:

FIG. 1 is a schematic view of a device for testing the surface quality of a component,

FIG. 2 is a schematic detailed view of a surface region of the component to be tested, regions lacking surface quality being visible on the surface.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

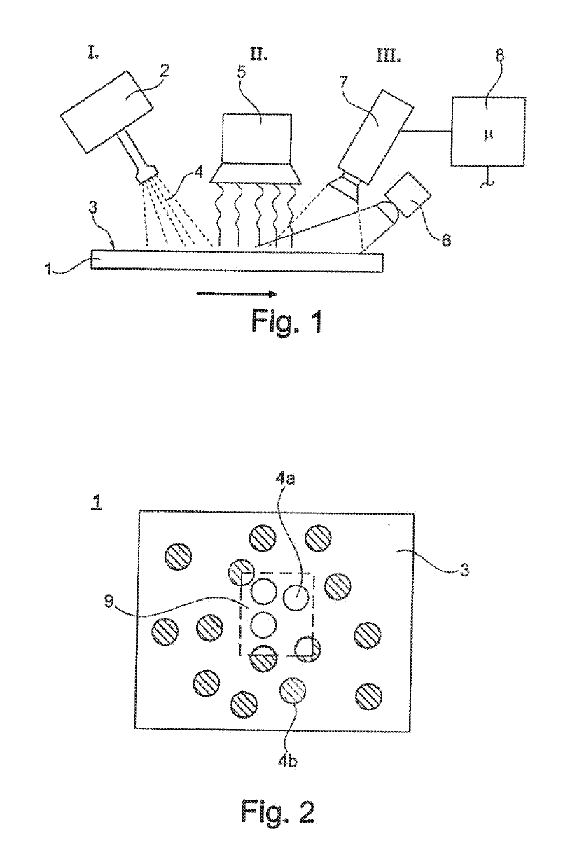

According to FIG. 1, a device for testing the surface quality of a component 1, which is for example a CFRP component in this case, substantially consists of a spraying unit 2 for wetting a surface 3 of the component 1 with a test liquid 4. The test liquid 4 is a fluorescent primer having both illuminating properties and adhesion promotion properties. The test liquid 4, which is applied to the surface 3 of the component 1 by means of the spraying unit 2 in the form of a thin film, is then dried on the surface 3 by means of a radiating heat source 5 in the form of a heat screen. If the surface 3 is then irradiated by means of a light source 6 pointing towards the surface, regions (not shown in more detail in this case) that lack surface quality become optically visible. The light source 6 emits ultraviolet light, with the result that the optical visibility is particularly obvious on account of differences in fluorescence of the primer on the surface 3.

In order to automate the test method, an optical camera unit 7 is also provided in the example device and detects, as image signals, the regions on the surface 3 of the component 1 which lack surface quality. A downstream electronic evaluation unit 8 compares the patterns of the detected image signals with stored image patterns in order to identify and display significant regions lacking surface quality.

In the automated test method, the component 3 is passed through the device in the arrow direction shown, the test liquid 4 first being applied to the surface 3 of the component 1 at a station I.. At a second station II., the sprayed-on fluorescent test liquid 4 is dried by means of a radiating heat source 5 pointing towards the surface 3. At a third station III., regions of the component 1 which lack surface quality are detected and evaluated by means of an ultraviolet light source 6 in combination with an optical camera unit 7.

FIG. 2 shows an example image of part of a surface 3 of the component 1. A region 9 which lacks surface quality and has a poor bonding property as a result of being contaminated with silicone, for example, is located on this surface (inside the dashed line). This region 9 can be identified by the droplets of dried test liquid 4a located therein, which have a much lower fluorescence than droplets of dried test liquid 4b which are adjacent to the region 9 and have a comparatively high fluorescence.

As a result of the primer property integrated in the test liquid 4, at least some of the impurities can be rendered safe, and improved adhesion suitability is produced for subsequently coating the component with a top coat or bonding it to another component, without requiring a cleaning step. However, if the test method reveals additional and larger regions having comparatively poorer surface quality, as a result of the test method a decision can be made to first clean the surface of the component 3 before additional surface-sensitive processing is carried out.

The invention is not restricted to the embodiment described above. Rather, modifications are also conceivable and are covered by the scope of protection of the following claims. It is thus also possible, for example, to carry out the test method according to the invention purely by hand. Likewise, a separate heat source can optionally also be dispensed with if, in certain applications, particularly fast drying of the florescent primer on the surface 3 of the component 1 is not necessary.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A method for testing the surface quality of a component, to demonstrate the suitability of the component for coating or bonding, in which the surface of the component is wetted with a test liquid, comprising:
applying a fluorescent primer as the test liquid; and subsequently drying the primer on the surface and irradiating by means of a light source such that regions lacking surface quality become optically visible on the surface by means of fluorescence.

2. The method of claim 1, wherein the fluorescent primer is sprayed onto the surface.

3. The method of claim 2, wherein the sprayed-on fluorescent primer is dried by means of a radiating heat source pointing towards the surface.

4. The method of claim 1, wherein primarily ultraviolet light is emitted by the light source.

5. The method of claim 1, wherein the optical visibility is produced by means of differences in fluorescence of the primer on the surface such that regions lacking surface quality show up on account of a noticeably low fluorescence.

6. The method of claim 1, wherein regions lacking surface quality are additionally converted into regions having sufficient bonding suitability on account of the primer property integrated into the test liquid.

7. A device for testing the surface quality of a component, comprising:
a spraying unit for wetting the surface of the component with a test liquid, the test liquid being a fluorescent primer which, after having been dried and an irradiating light source pointing towards the treated surface, that optically displays regions lacking surface quality.

8. The device of claim 7, further comprising:
an optical camera unit for detecting the regions lacking surface quality which is pointed towards the surface of the component.

9. The device of claim 8, wherein the optical camera unit is coupled to a downstream electronic evaluation unit in order to identify the detected image signals lacking surface quality by comparing patterns.

10. The device of claim 7, further comprising:
a radiating heat source that is pointed towards the surface of the component in order to dry the test liquid.

11. The device of claim 7, wherein the surface of the component is textured.

12. The device of claim 7, wherein the component to be tested comprises a CFRP component.

13. A method for testing the surface quality of a component, to demonstrate the suitability of the component for coating or bonding, in which the surface of the component is wetted with a test liquid, comprising:
applying a fluorescent primer as the test liquid; and subsequently drying the primer on the surface and irradiating by means of a light source such that regions lacking surface quality become optically visible on the surface by means of fluorescence;
wherein the fluorescent primer is sprayed onto the surface; and
wherein the sprayed-on fluorescent primer is dried by means of a radiating heat source pointing towards the surface.

14. The method of claim 13, wherein primarily ultraviolet light is emitted by the light source;
wherein the optical visibility is produced by means of differences in fluorescence of the primer on the surface such that regions lacking surface quality show up on account of a noticeably low fluorescence; and
wherein regions lacking surface quality are additionally converted into regions having sufficient bonding suitability on account of the primer property integrated into the test liquid.
